(19) United States
(12) Patent Application Publication
(10) Pub. No.: US 2026/0003700 A1
(43) Pub. Date: Jan. 1, 2026

(54) SOURCE OF TRUTH DATABASE MANAGEMENT AUTOMATION

(71) Applicant: Raytheon Company, Tewksbury, MA (US)

(72) Inventors: Benjamin C. Churchill, Spokane, WA (US); Nicholas W. Barrett, Oro Valley, AZ (US); Kristofer M. Hanson, Tucson, AZ (US); Robert G. Genis, Tucson, AZ (US); Jackye C. Wesley, Tucson, AZ (US)

(21) Appl. No.: 18/755,042

(22) Filed: Jun. 26, 2024

(51) Int. Cl. G06F 9/54; G06F 8/77

(52) U.S. Cl. CPC G06F 9/542; G06F 8/77

(57) ABSTRACT

Systems, devices, methods, and computer-readable media for source of truth storage device management are provided. A method can include receiving, by an event application programming interface (API), a first request to update source of truth data in a source of truth storage device to a new value, formatting, by the event API, a second request, issuing the second request to the source of truth storage device, and updating, by the source of truth storage device, an entry that corresponds to the source of truth data to the new value.

### TECHNICAL FIELD

Embodiments regard automating source of truth data updates to a source of truth storage device.

### BACKGROUND

Entities often have many different sources of truth for the applications that they manage. A reason there can be many sources of truth is because each source of truth is only capable/responsible for tracking a certain aspect of the information. For example, there can be a source of truth for security information, another for general information, another for business contacts, another for usage statistics, another for the technology stack, etc.

The combination of various sources of truth information is important for decisions and management of the applications. The decisions and management can be very costly if based on incorrect knowledge of the applications.

Keeping all these systems of truth up-to-date is typically a manual process, including human intervention after deployment. These systems of truth are usually off-the-shelf software with a web user interface (UI) front end through which an individual can update data. Keeping the source of truth information updated in a timely fashion quickly becomes intractable for even a few dozen applications that see regular updates. Additionally, the people who would be able to update this information accurately likely are not the people who should be managing these sources of truth.

### BRIEF DESCRIPTION OF DRAWINGS

FIG. 1 illustrates, by way of example, a diagram of an embodiment of a system that does not include automated source of truth publication and propagation.

FIG. 2 illustrates, by way of example, a system that includes automated source of truth information management.

FIG. 3 illustrates, by way of example, a diagram of an embodiment of the event API of FIG. 2.

FIG. 4 illustrates, by way of example, a diagram of an embodiment of a method for source of truth data storage device management.

FIG. 5 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

Entities do not always have access to critical information from which to base decisions regarding their applications. CI/CD pipelines (or Continuous Integration/Continuous Delivery pipelines) are industry standard for deploying applications. CI/CD pipelines watch a code repository for changes, perform various operations to build and test the application, and release it into production. As the pipeline builds and deploys, it discovers and/or produces authoritative information about the application, such as utilized technology, deployment location, application version, security scan results, etc. However, this information is inaccessible to anyone other than software developers because the information is localized entirely within the pipeline.

Additionally, other systems in the company may have valuable, authoritative source of truth application data (for example, personnel contacts in the form of an administrative group). However, sources of truth are typically heavily locked down behind permission walls and not available to those developing or maintaining software applications. So, this valuable information is trapped inside the CI/CD systems.

The source of truth information can be automatically updated in a source of truth database (or databases). Embodiments include an architectural pattern for automatically updating source-of-truth systems for an application so that entities tasked with managing the applications can be certain they have up-to-date information regarding their applications.

Embodiments provide automated publishing source of truth events (from pipelines and other systems) and propagate the source of truth events to the source of truth databases and any other interested, sufficiently credentialed systems. Embodiments accomplish this by publishing events via fire-and-forget HTTP requests to an event application programming interface (API). Then the events are propagated directly to source-of-truth systems and published to a message broker.

Getting information out of a software development pipeline automatically and as it becomes available or is discovered by the pipeline for portfolio management systems is new. Pipelines often trigger and create important information and automatically updating a source of truth datasource based on the important information is new. Pipelines are automation tools and not thought of as event mechanisms for purposes outside of building and deploying software. But they can be both and embodiments use the software pipeline to automatically harvest and update source of truth data.

As mentioned, pipelines are not generally known as producers of source of truth data events for portfolio management purposes. Pipelines exist for technical purposes, such as automating application deployment. Automatically emitting source of truth data application information from the pipeline is new.

Features of applications (such as a user-manageable admin list, location of the application files, results of application testing, results of code analysis, version to be deployed, which cloud resources are allocated for providing access to the application, whether the application is deployed or not, or the like) have not been considered as events to be published to source of truth systems. Developing features for publication is (mostly) an orthogonal concern to software management. So not all systems are seen as producers of authoritative source of truth data.

Source-of-truth systems are typically accessible through a permission wall (an authenticator through which a user verifies that they are allowed to access and/or alter source of truth data) and already have manual updating features (such as through a user interface (UI)). The source of truth systems do not support asynchronous messaging protocols. But typically, source of truth systems have an API to allow data integrations. A popular API method uses hypertext transfer protocol (HTTP) messaging. Allowing the publication of events over “fire-and-forget” HTTP requests allows for flexible means of propagating the source of truth events to various source-of-truth systems while also converting them to asynchronous messages. The HTTP requests include source of truth data and an identifier that uniquely identifies a type of the source of truth data. An event API maps the identifier to a storage location for the source of truth data.

Using HTTP requests additionally addresses permission walls. The HTTP request includes an authorization token and corresponding metadata that allows the event API to ensure that the user making the request has sufficient permissions to alter the source of truth data.

Additionally, integrating with each source-of-truth system individually and over HTTP requires all producers to understand the various APIs provided by each source of truth system. An adapter pattern implemented by the event API allows the event API to abstract the various APIs away, creating a single, simplified interface for all event publishers.

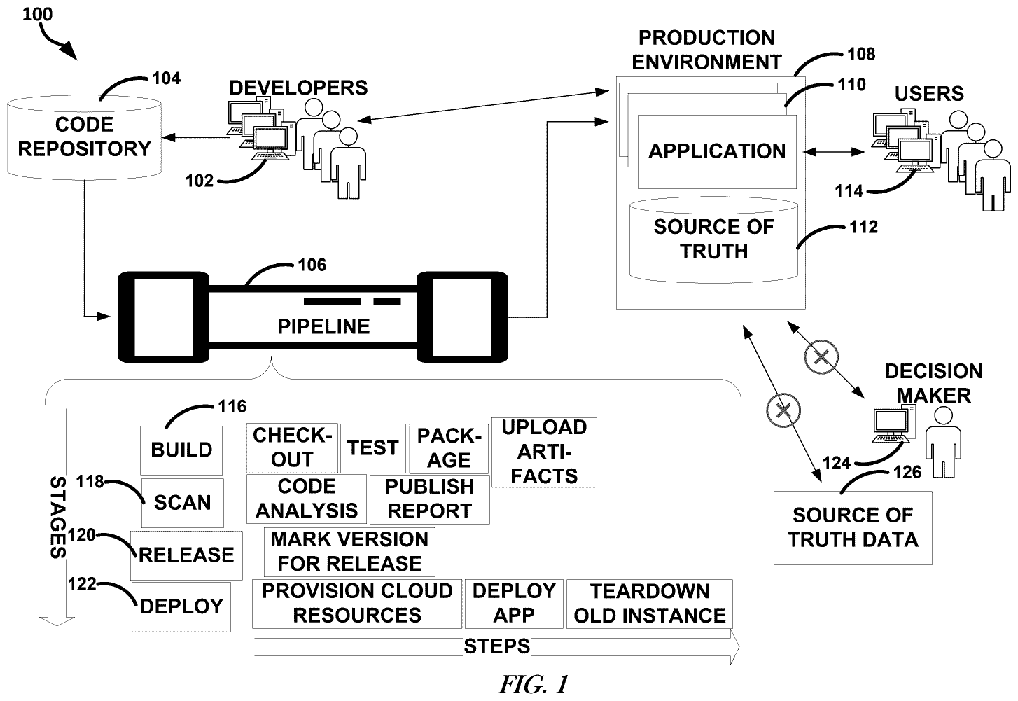

FIG. 1 illustrates, by way of example, a diagram of an embodiment of a system 100 that does not include automated source of truth publication and propagation. The system 100 as illustrated includes a code repository 104 coupled to a software application development pipeline 106. The pipeline 106 provides applications 110 for a production environment 108. Source of truth data for the applications 110 is stored in one or more source of truth databases 112.

Software developers 102 are personnel that develop and/or manage code for the software applications 110. The software developers 102 have permissions required to access and/or alter at least a portion of the code in the code repository 104. As the code developers 102 change the code for an application, the pipeline 106, with the aid of the developers 102, picks up the changes and builds and deploys the applications 110 into the production environment 108.

The software development pipeline 106 includes stages and steps to be carried out in each of the stages. An example of the stages and the steps are provided in FIG. 1, however some stages and steps may be different in some pipelines. The scope and specific operation of the pipeline 106 is not of consequence to automating source of truth data publication and propagation out of the pipeline 106.

The stages of the pipeline 106 that are illustrated include a build stage 116, a scan stage 118, a release stage 120, and a deploy stage 122. Each of the stages 116, 118, 120, 122 includes one or more steps to be completed to close out the stage. The build stage 116, for example, includes the steps of checking out code, testing the code, packaging the code (into an executable file for example) and uploading artifacts. Artifacts define behavior and functionality of software, such as with control sequences or database requests. Artifacts are like roadmaps that software developers 102 can use to trace the entire development process. The other stages are likewise defined by steps. These steps are not new and are well known by software developers.

After the software has been through all stages 116, 118, 120, 122 of the pipeline 106, the applications 110 are deployed to the production environment 108. In the production environment 108, the applications 110 are accessible to users 114 with sufficient permissions. The production environment 108 can be a local or remote server that hosts the applications 110. Many modern applications 110 are deployed to the cloud, which hosts the applications 110.

A system external to the pipeline 106 and possibly the production environment 108 can also include source of truth data 126. This external system does not have access to the database 112 and thus does not have the ability to update source of truth data in the database 112.

A decision maker 124 is an entity that manages the applications 110 and/or access to the applications 110. The decision maker 124 often does not have access to all of the available detailed source of truth data 112 in the pipeline 106 or production environment 108. Thus, the decision maker 124 does not have access to the most accurate representation of the source of truth data and is making decisions based on outdated or limited information.

The production environment 108 can also include one or more databases 112 that store source of truth data. The databases 112 can be accessible to those responsible for managing the applications 110, such as one or more of the developers 102, an information technology (IT) specialist, a combination thereof, or the like. The database 112 is any agreed upon authoritative system that serves as the source of accurate data regarding the applications 110. The source of truth data is not updated as the developers 102 update the code repository 104 or as the code moves through the pipeline 106, unless a human being manually updates the source of truth data. Thus, there is authoritative information (source of truth data) that is trapped in the pipeline 106 and other systems, such as the production environment.

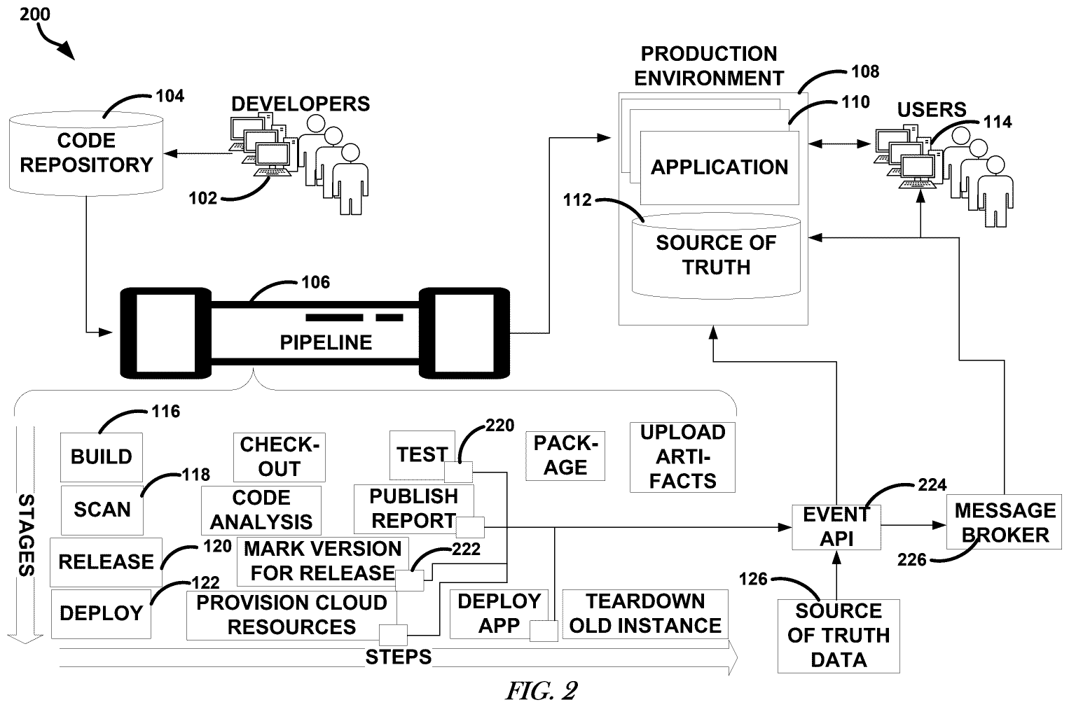

FIG. 2 illustrates, by way of example, a system 200 that includes automated source of truth information management. The system 200 includes some of the same components as the system 100 including the code repository 104, pipeline 106, and production environment 108. The system 200 includes additional components including an event application programming interface (API) 224, automatic source of truth data distribution scripts 220, 222 deployed at relevant steps of the pipeline 106, and a message broker 226. While FIG. 2 show distribution scripts deployed at the test, publish report, mark version for release, provision cloud resources, and deploy application steps, the distribution scripts can be deployed at more or fewer of the steps. Also, not all of the distribution scripts include reference labels so as to not obscure the view in FIG. 2.

The distribution scripts 220, 222 are deployed to steps of the pipeline corresponding to entries in the source of truth database 112. For example, if an entry in the source of truth database 112 calls for results of application testing, the source of distribution script 220 can be set up to automatically push an HTTP request to the event API 224. The HTTP request can indicate the results of the test, permissions for altering the corresponding entry in the source of truth database 112, and an identifier (ID) uniquely identifying the entry. The HTTP request can be a fire and forget HTTP request that is triggered by an update to the test step in the pipeline 106. Similar HTTP requests can be configured to be triggered in other steps of the pipeline 106.

The event API 224 can receive requests from the pipeline 106 and other sources, such as an external system that generates the source of truth data 126, the decision maker 124, or the like. The requests from the pipeline 106 and other sources can be in different formats. The event API 224 translates the request into a format compatible with the source of truth database 112. The event API 224 maps the unique identifier in a received request to a destination in the source of truth database 112. The event API 224 then assembles a request to the source of truth database 112 to update the entry corresponding to the identifier.

The event API 224 can serve as an authorization validation in addition to serving as a request formatter and source of truth data publisher. The event API 224 can compare permissions data regarding who is allowed to alter the entry associated with the unique identifier with the credentials supplied with a given request. If the comparison indicates that the entity that issued the request does have sufficient permissions, the event API 224 can issue a properly formatted request to the source of truth database 112 along with the credentials so that the source of truth data can be updated. If the comparison indicates that the entity that issued the request does not have sufficient permissions, the event API 224 can discard the request without issuing a request to the source of truth database 112. Additionally, or alternatively, the event API 224 can have and maintain its own credentials. The credentials from the event API 224 can be used by the event API 224 to authenticate with the source of truth database 112. This way, the event API 224 is harder to spoof and only those with valid credentials can authenticate and change source of truth data in the source of truth database 112.

In general, an API is a software mechanism that enables two software components to communicate with each other using a set of definitions and protocols. The API understands the formats of data required by the components and converts a communication from one format to another format. APIs can include additional functionality beyond formatting.

The message broker 226 allows the users 114, applications 110, decision maker 124, or the like, to subscribe to source of truth data. Then when the source of truth data to which the entity is subscribed changes, the message broker 226 issues a communication to the entity. The communication can indicate that the data has changed, what the data changed to, or the like. The user 114, application 110, or other entity can then access the source of truth data storage device to see the new source of truth data if the communication does not include the new value.

The decision maker 124 can issue a request to the event API 224 to access the source of truth data in the source of truth database 112. The decision maker 124 can issue a request to alter the source of truth data in the source of truth database 112. The event API 224 can issue a request to read or write data to/from the database 112. The event API 224 can format the data returned from the database 112 in a format compatible with the device of the decision maker 124. Since the event API 224 understands the permissions associated with the source of truth data in the database 112, the event API 224 can serve as a check to ensure that the decision maker 124 has sufficient permissions to access the source of truth data required for making a decision. The event API 224, along with the distribution scripts 220, 222 ensure that the decision maker 124 has access to the most recent source of truth data for the applications 110. This access is automatically managed by the event API 224 and the distribution scripts automatically (without human interference after deployment).

An example of a distribution script 220, 222 is provided:

PATCH/applications/some-internal-app HTTP/1.1
Host: event-proxy-api.business.com
Accept: application/json
...

Examples of bodies of the distribution scripts 220, 222 are provided:

```
{
  ″latestedReleaseableVersion″: ″1.0.2″
}
{
  ″lastSecurityScanDate″: ″01-01-2024″
}
{
  ″database″: ″Oracle″,
  ″databaseVersion″: ″21.1.4″,
  ″compute″: ″aws-ec2-t3a.large″,
  ″os″: ″Ubuntu″,
  ″osVersion″: ″18.0.2″,
}
{
  ″releasedVersion″: ″1.0.2″,
  ″releaseDate″: ″01-01-2024″
}
{
  “businessOwner″: “George P. Burdell″
}
{
  “lastSuccessfulTest″: ″01-01-2024“,
  “codeCoverage”: 0.86
}
```

Embodiments include an architectural pattern for automatically updating source-of-truth systems that solve one or more problems of ensuring source of truth data is up-to-date. The source of truth data is critical information from which to base decisions. The architectural pattern accomplishes this by enabling the publication and propagation of portfolio data using the event API 224 and the distribution scripts 220, 222 (sometimes called publication scripts).

In general, there are six steps to the process afforded by the architecture, where steps three and four are new. Steps one and two are industry standard. Developers push code changes to a code repository, which in turn automatically kicks off the code pipeline 106 build process. During the pipeline build process, the pipeline 106 begins to discover or produce source of truth data. The pipeline 106 publishes this data as it is discovered, through the distribution scripts 220, 222 to the event API 224.

Alternatively, step three can have another system, such as the system that generated the source of truth data 126 and publish that data, via a distribution script, to the event API 224. This could be during some arbitrary event, such as granting a user administration permissions in a web app, for example.

While this will likely be done over HTTP, it is possible to send events to the event API 224 over some asynchronous messaging protocol. The event API 224 updates source of truth systems, such as the database 112.

This is an important step because most source of truth systems do not support asynchronous messaging. Each source of truth also exposes its own API (which is often complex), requiring consumers to know how to use each specific API. The event API 224 abstracts each individual API away by exposing its own, uniform API (from the view of systems that push distribution requests to the event API 224) and adapting it to each source of truth storage device. This ensures source of truth systems are updated automatically.

The Event Proxy API publishes events to the message broker 226 via asynchronous messaging. This allows any of the applications or users 114 (including the decision maker 124) to stay informed of updated source of truth data. The event API 224 knows how to adapt events to each of the source of truth systems, which introduces some coupling between them. The message broker 226 allows the event API 224 to publish to any number of consumers without any coupling between the API 224 and the consumers. Thus events are propagated to all necessary systems and any volunteer systems through the message broker 226. The message broker 226 informs all systems that are interested in events. The message broker 226 distributes the events to entities other than the source of truth data storage systems.

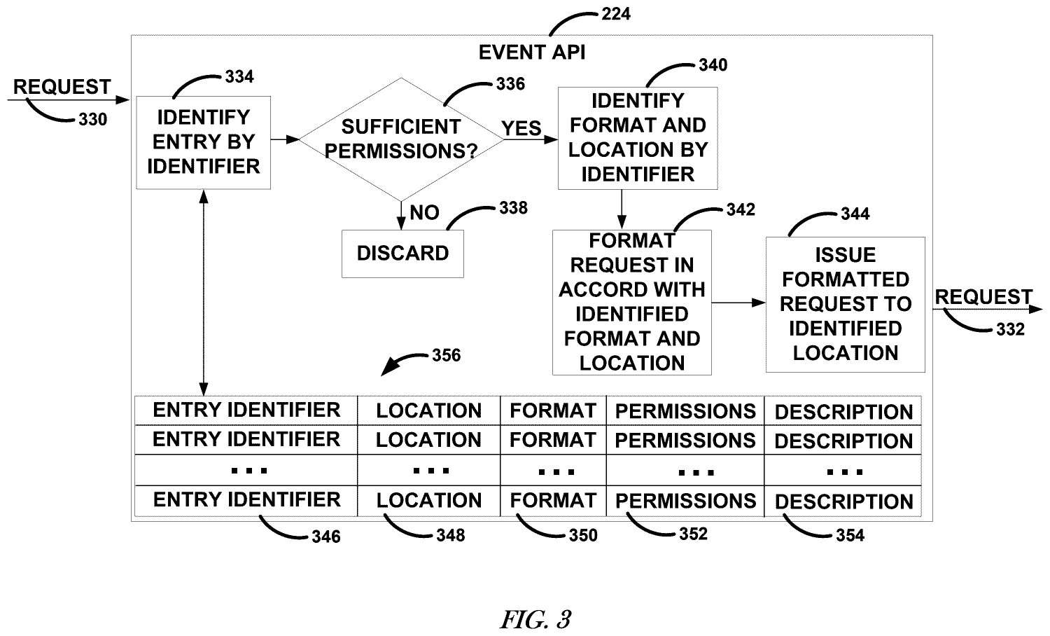

FIG. 3 illustrates, by way of example, a diagram of an embodiment of the event API 224. The event API 224 performs operations for receiving a request 330 to publish source of truth data and issuing a different request 332 to distribute or store the source of truth data. The request 330 includes an identifier that uniquely identifies the source of truth data that is to be written over, what data is to be written as a new value for the source of truth data associated with the identifier, and credentials of the entity that issued the request 330. At operation 334, the event API 224 matches the identifier to a table 356 indexed by unique source of truth data identifiers 346. Each entry in the table 356 includes data indicating an identifier, a location 348 of the source of truth data in a source of truth storage device, a format 350 in which the source of truth data is stored in the source of truth storage device and of the request 332 to overwrite the source of truth data, permissions 352 required to overwrite the source of truth data, and a general description 354 of the source of truth data.

At operation 336, the event API 224 determines whether the entity that issued the request 330 has sufficient permissions to overwrite the source of truth data. If the entity does not have sufficient permissions, the request is discarded at operation 338 and no source of truth data is overwritten. If the entity does have sufficient permissions, the event API 224 performs operation 340.

At operation 340, the event API 224 identifies the format 350 of the request 332 and the source of truth data and location 348 at which the source of truth data is stored. At operation 342, the event API 224 formats the request 332 in accord with the identified format 350 and location 348. At operation 344, the event API 224 issues the formatted request 332 to the identified location. The formatted request 332 can be for writing source of truth data to the source of truth storage device, alerting the message broker 226 of a change to source of truth data, or a combination thereof. Thus, for each request 330, the event API 224 can issue multiple requests.

The request 330 can be to update multiple source of truth entries. An example of such a request is provided:

```
[
  {
    ″op″: ″replace″,
    ″path″: ″/businessOwners″,
    ″value″: ″JSmith123″
  },
  {
    ″op″: ″replace″,
    ″path″: ″/disposition″,
    ″value″: ″Retain″
  }
]
```

The event API 224 can generate multiple requests 332 to handle such a request 330. An example of multiple requests generated by the event API 224 to handle the request of the previous paragraph are provided:

```
HTTP PATCH https://.../application/{mapped-id}
[
  {
    ″op″: ″remove″,
    ″path″: ″businessOwner″,
    ″value″: {“externalID”: ″JDoe456″}
  },
  {
    ″op″: ″add″,
    ″path″: ″businessOwner″,
    ″value″: {“externalID”: ″JSmith123″}
  },
]
HTTP POST https://.../application
  {
    ″_id″: <mapped-id>,
    ″_type″: ″Application″,
    ″disposition″: ″Retain″
  }
```

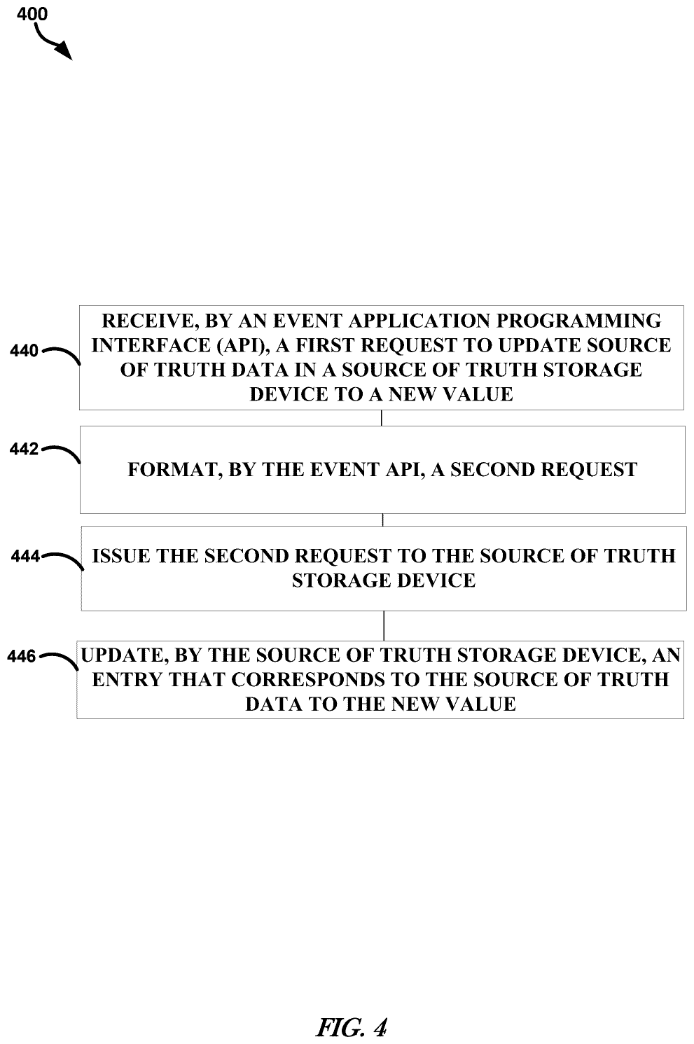

FIG. 4 illustrates, by way of example, a diagram of an embodiment of a method 400 for source of truth storage device management. The method 400 as illustrated includes receiving, by an event application programming interface (API), a first request to update source of truth data in a source of truth storage device to a new value, at operation 440; formatting, by the event API, a second request, at operation 442; issuing the second request to the source of truth storage device, at operation 444; and updating, by the source of truth storage device, an entry that corresponds to the source of truth data to the new value, at operation 446.

The method 400 can further include issuing, by a distribution request script, the first request to the event API. The distribution request script can be part of a software development pipeline. The distribution request script can automatically generate the first request responsive to an event occurring in the software development pipeline. The first request can include an identifier uniquely indicating the source of data to be updated. Formatting the second request can include looking up, by the event API, a location of the source of truth data in a network based on the identifier. The event API can issue the second request to the location.

The first request can further include credential information. The method 400 can further include comparing, by the event API, the credential information to credential information associated with the identifier. The method 400 can further include issuing the second request only if the credential information in the second request satisfies the credential information associated with the identifier. The method 400 can further include issuing, by the event API, a third request to a message broker to which users and applications subscribe to get updates to source of truth data, the third request indicating the source of truth data that is updated by the first request.

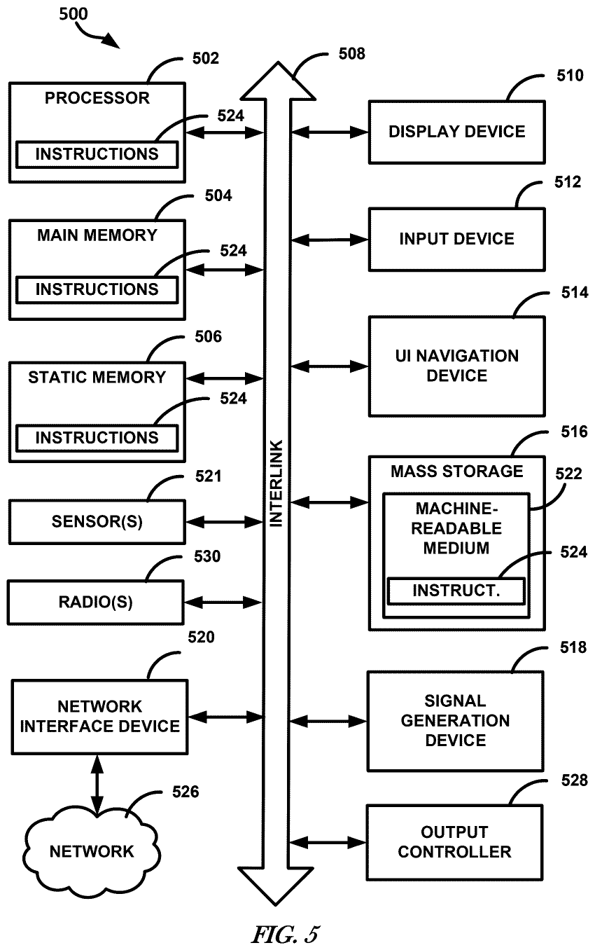

FIG. 5 illustrates, by way of example, a block diagram of an embodiment of a machine in the example form of a computer system 500 within which instructions, for causing the machine to perform any one or more of the methods or techniques discussed herein, may be executed. One or more of the code repository 104, software development pipeline 106, production environment 108, developer device, user device, decision maker device, event API 224, distribution request script 220, 222, operations 334, 336, 338, 340, 342, 344, lookup table 356, method 400, or other component, operation, or technique, can include, or be implemented or performed by or can include one or more of the components of the computer system 500. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display device 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a mass storage unit 516, a signal generation device 518 (e.g., a speaker), a network interface device 520, and a radio 530 such as Bluetooth, WWAN, WLAN, and NFC, permitting the application of security controls on such protocols.

The mass storage unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present teachings, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 524 may further be transmitted or received over a communications network 526 using a transmission medium. The instructions 524 may be transmitted using the network interface device 520 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### ADDITIONAL EXAMPLES

Example 1 includes a method for source of truth storage device management, the method comprising receiving, by an event application programming interface (API), a first request to update source of truth data in a source of truth storage device to a new value, formatting, by the event API, a second request, issuing the second request to the source of truth storage device, and updating, by the source of truth storage device, an entry that corresponds to the source of truth data to the new value.
In Example 2, Example 1 further includes issuing, by a distribution request script, the first request to the event API.
In Example 3, Example 2 further includes, wherein the distribution request script is part of a software development pipeline.
In Example 4, Example 3 further includes, wherein the distribution request script automatically generates the first request responsive to an event occurring in the software development pipeline.
In Example 5, at least one of Examples 1˜4 further includes, wherein the first request includes an identifier uniquely indicating the source of data to be updated, formatting the second request includes looking up, by the event API, a location of the source of truth data in a network based on the identifier, and the second request is issued to the location.
In Example 6, Example 5 further includes, wherein the first request further includes credential information, and the method further comprises comparing, by the event API, the credential information to credential information associated with the identifier, and issuing the second request only if the credential information in the second request satisfies the credential information associated with the identifier.
In Example 7, at least one of Examples 1-6 further includes issuing, by the event API, a third request to a message broker to which users and applications subscribe to get updates to source of truth data, the third request indicating the source of truth data that is updated by the second request.
Example 8 includes a non-transitory machine-readable medium including instructions that, when executed by a machine, cause the machine to perform operations for source of truth storage device management, the operations comprising receiving, by an event application programming interface (API), a first request to update source of truth data in a source of truth storage device to a new value, formatting, by the event API, a second request, issuing the second request to the source of truth storage device, and updating, by the source of truth storage device, an entry that corresponds to the source of truth data to the new value.
In Example 9, Example 8 further includes, wherein the operation further comprises issuing, by a distribution request script, the first request to the event API.
In Example 10, Example 9 further includes, wherein the distribution request script is part of a software development pipeline.
In Example 11, Example 10 further includes, wherein the distribution request script automatically generates the first request responsive to an event occurring in the software development pipeline.
In Example 12, at least one of Examples 8-11 further includes, wherein the first request includes an identifier uniquely indicating the source of data to be updated, formatting the second request includes looking up, by the event API, a location of the source of truth data in a network based on the identifier, and the second request is issued to the location.
In Example 13, Example 12 further includes, wherein the first request further includes credential information, and the operations further comprise comparing, by the event API, the credential information to credential information associated with the identifier, and issuing the second request only if the credential information in the second request satisfies the credential information associated with the identifier.
In Example 14, at least one of Examples 8-13 further includes, wherein the operations further comprise issuing, by the event API, a third request to a message broker to which users and applications subscribe to get updates to source of truth data, the third request indicating the source of truth data that is updated by the second request.
Example 15 includes a system for source of truth storage device management, the system comprising an event application programming interface (API) configured to receive a first request to update source of truth data in a source of truth storage device to a new value, format a second request, issue the second request to the source of truth storage device, and the source of truth storage device configured to update, responsive to the second request, an entry that corresponds to the source of truth data to the new value.
In Example 16, Example 15 further includes a distribution request script configured to issue the first request to the event API.
In Example 17, Example 16 further includes a software development pipeline, wherein the distribution request script is part of the software development pipeline.
In Example 18, Example 17 further includes, wherein the distribution request script automatically generates the first request responsive to an event occurring in the software development pipeline.
In Example 19, at least one of Examples 15-18 further includes, wherein the first request includes an identifier uniquely indicating the source of data to be updated, the event API is configured to formatting the second request by looking up a location of the source of truth data in a network based on the identifier, and the second request is issued to the location.
In Example 20, Example 19 further includes, wherein the first request further includes credential information, and the event API is further configured to compare the credential information to credential information associated with the identifier, and issue the second request only if the credential information in the second request satisfies the credential information associated with the identifier.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for source of truth storage device management, the method comprising:
receiving, by an event application programming interface (API), a first request to update source of truth data in a source of truth storage device to a new value;
formatting, by the event API, a second request;
issuing the second request to the source of truth storage device; and
updating, by the source of truth storage device, an entry that corresponds to the source of truth data to the new value.

2. The method of claim 1, further comprising:
issuing, by a distribution request script, the first request to the event API.

3. The method of claim 2, wherein the distribution request script is part of a software development pipeline.

4. The method of claim 3, wherein the distribution request script automatically generates the first request responsive to an event occurring in the software development pipeline.

5. The method of claim 1, wherein:
the first request includes an identifier uniquely indicating the source of data to be updated,
formatting the second request includes looking up, by the event API, a location of the source of truth data in a network based on the identifier, and
the second request is issued to the location.

6. The method of claim 5, wherein the first request further includes credential information, and the method further comprises:
comparing, by the event API, the credential information to credential information associated with the identifier, and
issuing the second request only if the credential information in the second request satisfies the credential information associated with the identifier.

7. The method of claim 1, further comprising issuing, by the event API, a third request to a message broker to which users and applications subscribe to get updates to source of truth data, the third request indicating the source of truth data that is updated by the second request.

8. A non-transitory machine-readable medium including instructions that, when executed by a machine, cause the machine to perform operations for source of truth storage device management, the operations comprising:
receiving, by an event application programming interface (API), a first request to update source of truth data in a source of truth storage device to a new value;
formatting, by the event API, a second request;
issuing the second request to the source of truth storage device; and
updating, by the source of truth storage device, an entry that corresponds to the source of truth data to the new value.

9. The non-transitory machine-readable medium of claim 8, wherein the operation further comprise:
issuing, by a distribution request script, the first request to the event API.

10. The non-transitory machine-readable medium of claim 9, wherein the distribution request script is part of a software development pipeline.

11. The non-transitory machine-readable medium of claim 10, wherein the distribution request script automatically generates the first request responsive to an event occurring in the software development pipeline.

12. The non-transitory machine-readable medium of claim 8, wherein:
the first request includes an identifier uniquely indicating the source of data to be updated,
formatting the second request includes looking up, by the event API, a location of the source of truth data in a network based on the identifier, and
the second request is issued to the location.

13. The non-transitory machine-readable medium of claim 12, wherein the first request further includes credential information, and the operations further comprise:
comparing, by the event API, the credential information to credential information associated with the identifier, and
issuing the second request only if the credential information in the second request satisfies the credential information associated with the identifier.

14. The non-transitory machine-readable medium of claim 8, wherein the operations further comprise issuing, by the event API, a third request to a message broker to which users and applications subscribe to get updates to source of truth data, the third request indicating the source of truth data that is updated by the second request.

15. A system for source of truth storage device management, the system comprising:
an event application programming interface (API) configured to:
receive a first request to update source of truth data in a source of truth storage device to a new value;
format a second request;
issue the second request to the source of truth storage device; and
the source of truth storage device configured to update, responsive to the second request, an entry that corresponds to the source of truth data to the new value.

16. The system of claim 15, further comprising a distribution request script configured to issue the first request to the event API.

17. The system of claim 16, further comprising a software development pipeline, wherein the distribution request script is part of the software development pipeline.

18. The system of claim 17, wherein the distribution request script automatically generates the first request responsive to an event occurring in the software development pipeline.

19. The system of claim 15, wherein:
the first request includes an identifier uniquely indicating the source of data to be updated,
the event API is configured to formatting the second request by looking up a location of the source of truth data in a network based on the identifier, and
the second request is issued to the location.

20. The system of claim 19, wherein the first request further includes credential information, and the event API is further configured to:
compare the credential information to credential information associated with the identifier, and
issue the second request only if the credential information in the second request satisfies the credential information associated with the identifier.
